(19) United States
(12) Patent Application Publication
(10) Pub. No.: US 2006/0007524 A1
(43) Pub. Date: Jan. 12, 2006

(54) Display member incorporating a patterned adhesive layer

(76) Inventor: Man C. Tam, Mississauge (CA)

Correspondence Address: PEPPER HAMILTON LLP, ONE MELLON CENTER, 50TH FLOOR, 500 GRANT STREET, PITTSBURGH, PA, 15219, US

(21) Appl. No.: 10/886,377

(22) Filed: Jul. 7, 2004

(51) Int. Cl. G02B 26/00

(52) U.S. Cl. 359/296

(57) ABSTRACT

A display medium including bichromal or multichromal display elements incorporates a patterned adhesive layer to position the display elements in a closely-packed monolayer. The closely-packed monolayer may provide improved contrast, brightness and image quality. A method of making such a display medium includes forming a patterned adhesive layer over a substrate and cascading display elements over the patterned adhesive layer, optionally several times to form a substantially uniform monolayer.

### BACKGROUND

1. Technical Field

The description set forth herein generally relates to display members and methods of manufacturing them. More particularly, the description relates to electronic paper-type displays and display members that include a patterned adhesive layer.

2. Description of Related Art

Display technologies based on encapsulation of electrophoretic particles, multichromal beads and liquid crystals have many potential applications in fields such as electronic paper and other digital document media. Examples of such electronic display devices include those available from Gyricon LLC of Ann Arbor, Mich. For example, as shown in FIG. 1, a group of bichromal beads, cylinders, crystals or other bichromal or multichromal particles 10 are dispersed in an elastomeric sheet swollen by a fluid 12 and positioned atop a conductive substrate 14 such as a printed circuit board. The particles, fluid and substrate are covered with a transparent layer 16 such as glass or plastic and a transparent conductive material such as indium tin oxide (ITO) 18, and they are sealed to form a re-addressable display material in which the particles rotate in response to an electric or magnetic field that is applied to the conductive substrate.

Bichromal displays have numerous advantages over conventional electrically addressable visual displays, such as LCD and CRT displays. In particular, they are suitable for viewing in ambient light, they retain an image indefinitely in the absence of an applied electric field, and they can be made lightweight, flexible, foldable, and with many other familiar and useful characteristics of ordinary writing paper. Thus, at least in principle, they are suitable both for display applications and for so-called electric paper or interactive paper applications, in which they serve as an electrically addressable, reusable substitute for ordinary paper. For further advantages of the bichromal display, see, for example, U.S. Pat. No. 5,389,945, which is herein incorporated by reference.

Current multichromal display devices are often produced by the “swollen sheet” method. In this method, bare multichromal beads, randomly mixed and dispersed in a silicone elastomeric sheet, are rendered rotatable by swelling the elastomer in silicone oil. Pockets of oil form around each bead, and the beads detach from the elastomer-bead interface. The resulting device thus includes a swollen elastomeric coating of bichromal particles. Additional detail about the swollen sheet production method may be found in, for example, U.S. Pat. No. 6,441,946, which is incorporated herein by reference in its entirety.

The current swollen sheet methods may result in a display layer that exhibits an undesirably low white reflectance in the background area of the displayed image. Consequently, the background area may appear objectionably dark gray rather than white to the viewer. High white reflectance is desirable in order to provide a higher contrast between the displayed image and the background. Examples of low white reflectance in current devices include levels under about 17%. These levels may result from the upper-level bichromal beads (i.e., those closest to the transparent layer and furthest from the conductive substrate) being spaced further apart than the lower-level beads. In some cases, the upper-level beads can cover less than 20% of the surface area. Low white reflectance may result when light passes through the interstices in the upper-level beads, is scattered and absorbed by the darker hemispheres of the beads, and is not reflected back to the observer.

In addition, the swollen sheet method can result in a display layer that requires a relatively high switching voltage in order to rotate the beads in the layer, since the layer is thickly coated and sealed in order to contain the swelling fluid. Furthermore, the elastomer sheet must be kept wet with oil in order for the capsules to maintain their rotation capabilities, as oil evaporation can cause collapse of the display layer cavity and result in immobilization of the beads. Plus, the display device must be sealed to contain the swelling fluid, resulting in increased cost and complexity.

To solve at least some of the problems listed above, U.S. Pat. No. 6,445,496, which is incorporated herein by reference in its entirety, describes a method of encapsulating the bichromal balls within an oil-filled capsule. The capsule is formed by chemical means. Encapsulation may eliminate the need for a costly elastomer and the sealing step. U.S. Pat. No. 6,492,025, incorporated herein by reference, describes an example of microcapsule composition. U.S. Pat. No. 6,488,870, incorporated herein by reference, describes examples of additional encapsulation processes. A display device describing a closely-packed monolayer of encapsulated bichromal balls is described in co-pending U.S. patent application No. _____, entitled “Contrast Enhancement in Multichromal Display by Incorporating a Highly Absorptive Layer,” filed Jul. 7, 2004, which is incorporated herein by reference in its entirety. Such a device may exhibit an improved white reflectance (e.g., in the range of about 20% to about 30%). In addition, it allows a thinner coating, thus enabling a lower switching voltage to be used to drive rotation of the beads.

During fabrication of a device using a closely-packed monolayer of encapsulated bichromal balls, the position of the capsules may become fixed once they come into contact with the adhesive layer. For example, as shown in FIG. 2, if the capsules 10 are spaced so that they are close enough to prohibit other beads from resting between the space (i.e., not near touching but less than one capsule diameter apart), the interstitial space 20 between the capsules will not accommodate another capsule. Accordingly, either a monolayer will not result, or the upper layers will cascade off of the monolayer. In either situation, packing will be less dense, and contrast and brightness will be diminished.

Accordingly, a need exists for a display device that is manufactured using an improved method of forming a monolayer of encapsulated beads.

### SUMMARY

In an embodiment, a display medium includes a substrate, a patterned adhesive layer on the substrate, and a number of display elements on the patterned adhesive layer. An at least substantially transparent overlayer, such as a counterelectrode, may be positioned over the display elements and opposite from the patterned adhesive layer. In an embodiment, the patterned adhesive layer forms a pattern of raised adhesive elements that project from the substrate. The display elements may be positioned in a monolayer in a pattern that substantially corresponds to the pattern of the patterned adhesive layer. In an embodiment, the display elements may have a substantially uniform diameter, and the raised adhesive elements may be spaced apart such that center-to-center spacing of the raised adhesive elements is slightly more than the diameter of the display elements.

Optionally, the raised adhesive elements have a lateral area (or width) that is between and about 5% and about 50% of the diameter of the display elements, although other sizes are possible. The display elements may include, and are not limited to, one or more of bichromal or multichromal particles, beads, capsules, cylinders or balls. The patterned adhesive layer may be made of a copolymer of styrene and acrylate, a polyester resin, polyurethane, a copolymer of acrylonitrile and vinylidene chloride, polyvinyl acetate, polyvinyl butyral, polyolefin, an epoxy, and/or another material.

In another embodiment, a method of manufacturing a display medium includes applying an adhesive material to a substrate. The adhesive material is passed through a patterned screen before reaching the substrate so that the adhesive material forms a patterned adhesive layer on the substrate. Suitable application methods include, and are not limited to, screen printing, ink jet printing, spray coating, gravure roll coating and/or other methods. When the patterned adhesive layer is made of a light-activated adhesive, the depositing step may also include photo patterning. The pattern of the patterned adhesive layer corresponds to the pattern of the patterned screen. The method also includes depositing a plurality of bichromal capsules on the patterned adhesive layer so that the capsules form a monolayer in positions that at least substantially correspond to the pattern of the patterned screen. The method also includes placing a conductive layer on the monolayer of capsules.

Optionally, the step of depositing capsules may be repeated two or more times to provide a substantially uniform monolayer. Also optionally, after the depositing step, capsules that do not adhere to the patterned adhesive layer may be removed. Optionally, the method may include vibrating the substrate during or after the depositing step.

### BRIEF DESCRIPTION OF THE DRAWINGS

FIG. 1 illustrates a side view of exemplary elements of a prior art electronic display.

FIG. 2 illustrates a side view of exemplary elements of a display member with a monolayer of beads but having undesired spacing between the bichromal capsules.

FIG. 3 illustrates a side view of a display member with a monolayer of capsules having improved spacing between the bichromal capsules.

FIG. 4 illustrates a side view of a substrate for a display member with a patterned adhesive layer positioned atop the substrate.

FIG. 5 illustrates a top view of an exemplary adhesive layer pattern.

FIG. 6 illustrates the view of FIG. 5 with a layer of capsules atop the adhesive layer.

FIG. 7 illustrates a side view of a display member with an optional transparent layer.

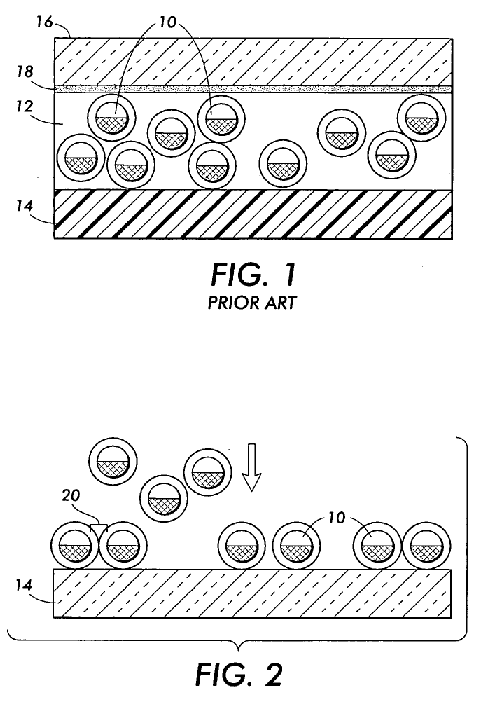

### DETAILED DESCRIPTION

Notations and Nomenclature

As used herein, the words “bichromal” and “multichromal” will be used interchangeably to refer to a display or a particle that may exhibit two or more colors. In addition, the words “bead”, “particle” and “capsule” are used interchangeably to refer to a bichromal element for a display medium, such as a twisting cylinder, microcapsule, bead, electrophoretic material or any other bichromal or multichromal material that may be modulated by an applied electric or magnetic field. For example, a bichromal bead in an oil-filled capsule may rotate inside the capsule in response to the applied field.

### DESCRIPTION

The description that follows generally relates to display members and methods of manufacturing them. In an embodiment, the description relates to electronic paper-type displays and display members that include a patterned adhesive layer

FIG. 3 illustrates exemplary elements of a display member according to one embodiment. The display member includes an image formation layer that includes a single layer, or monolayer, of encapsulated particles 10 positioned atop a conductive substrate 14. The conductive substrate 14 may be paper, conductive plastic, a printed circuit board or other material that may apply or pass a field to selected particles in the image formation layer. Between the particles 10 and the substrate 14 is a patterned adhesive layer 22. The particles may be positioned atop the adhesive layer 22 or at least partially embedded within the adhesive layer 22. The particles are covered with an overlayer, such as conductive material 18 that may act as a counterelectrode. The counterelectrode may be, for example, indium tin oxide (ITO) that is positioned on or under transparent layer 16. Together, the layers form a re-addressable display material in which the particles rotate in response to an electric or magnetic field that is applied to the image formation layer via the conductive substrate. The counterelectrode may be used to vary the field.

The capsules 10 may be or may contain any bichromal or multichromal display materials such as bichromal beads, electrophoretic particles, twisting cylinders and the like. The size of the capsules is preferably substantially uniform. When bichromal, the capsules and/or beads within the capsules are one color (such as white) on one surface and a different color (such as black) on the other surface. Multichromal capsules may have different configurations. For signage applications, the diameter of the capsules may be approximately 120 microns (μm), within which bichromal beads having a diameter of approximately 100 μm may be contained. Other capsule and particle sizes are possible within the invention.

The capsules 10 form a closely-packed monolayer configuration on the patterned adhesive layer 22. The closely-packed monolayer configuration minimizes absorption of the scattered light by the black or darker hemispheres, resulting in substantial improvement in brightness.

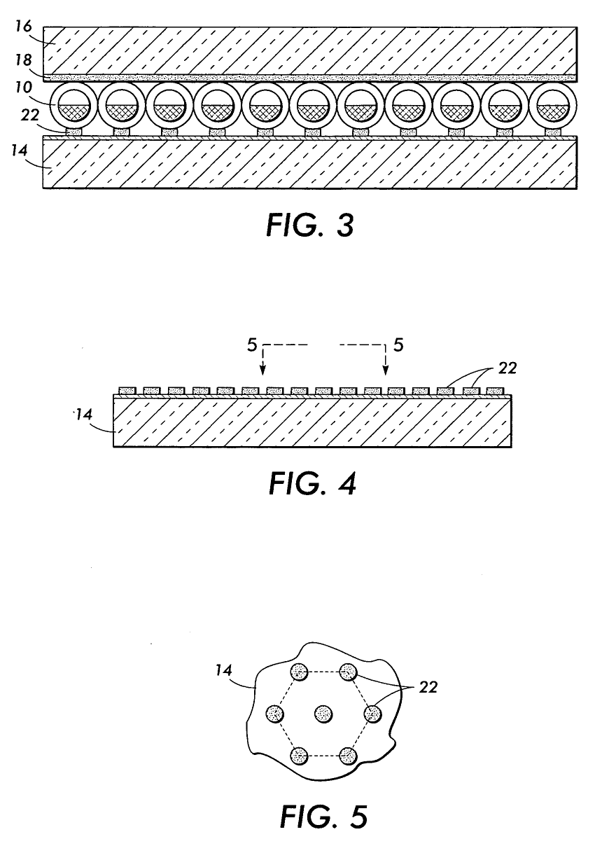

By providing a patterned adhesive layer 22, the capsules 10 may be anchored according to a pre-determined geometry that improves or maximizes packing density of the monolayer of capsules. For example, as illustrated in FIG. 4, the adhesive layer 22 may be patterned to provide raised elements at positions that are separated from each other at distances that are just slightly more than the diameter of the capsules. Thus, as illustrated in FIG. 3, when the adhesive layer 22 receives the capsules 10, the capsules are positioned in a closely packed monolayer.

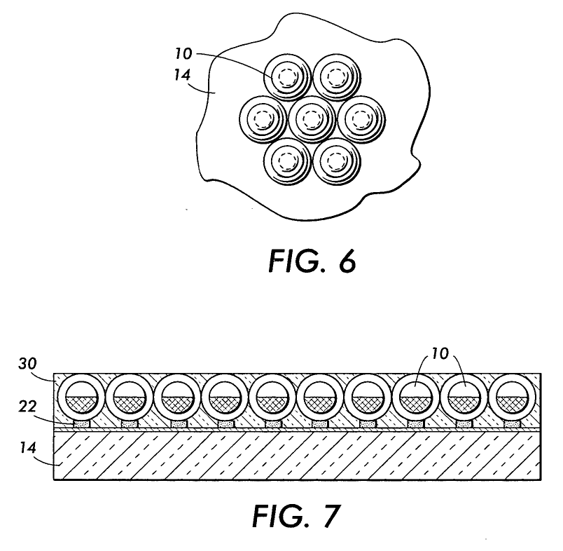

FIG. 5 illustrates an exemplary pattern in accordance with one embodiment. Referring to FIG. 5, the raised elements of the adhesive layer 22 are shown to be patterned in a hexagonal manner atop the substrate 14. The pattern may repeat over a larger area of the substrate as shown, and other patterns are possible. The hexagonal pattern such as that shown may provide a closely packed monolayer with up to 90% or more of surface coverage. For example, as shown in FIG. 6, when capsules 10 are positioned atop the patterned layer, the capsules may be densely packed. Such a close packing arrangement may result in a display material that exhibits a high white reflectance and contrast, a smaller thickness (which allows for a lower switching voltage), and improved resolution.

The adhesive layer may fix the capsules in place so that the capsules form a desired pattern when the capsules come into contact with the adhesive. For example, FIG. 5 shows a hexagonal adhesive layer. Other geometries can be used, such as a substantially hexagonal array, an at least substantially rectangular array, an at least substantially rhomboidal array and other shapes. When the capsules are fixed in place, the beads or particles inside of the capsules may rotate or otherwise move in response to an applied field.

The size and spacing of the adhesive later may vary in accordance with the desired application. As illustrated in FIGS. 4 and 5, the adhesive layer 22 may include dots, ridges or raised elements of adhesive material. The size and center-to-center spacing of the raised elements will depend on the size of the capsules used and the desired geometry in order to optimize capsule packing density. For example, in display sign applications, the capsules may have a diameter of about 120 microns (μm), and the capsules may be substantially uniform in size in order to optimize performance. In such an application, the adhesive layer may have a height or thickness of about 0.1 to about 20 μm. The width of the raised elements in this example may be about 5% to about 20% or even to about 50% of the diameter of the capsule. The center-to-center distance of the raised elements is preferably slightly more than 120 μm to provide close packing density. Of course, other sizes, heights and distances are possible, and they may be necessary with different size capsules. For example, smaller capsules may be used in applications requiring higher resolution, and the sizes associated with the patterned adhesive layer will also be smaller in such applications.

The adhesive layer 22 may be made of any suitable adhesive material, including but not limited to pressure-sensitive adhesives, heat-activated adhesives (i.e., those with adhesive properties that change with temperature) and/or light-activated adhesives (i.e., those with adhesive properties that change with light exposure). Exemplary materials include thermoplastic and thermosetting adhesives such as copolymers of styrene and acrylate, polyester resins, polyurethane, copolymers of acrylonitrile and vinylidene chloride, polyvinyl acetate, polyvinyl butyral, polyolefins, cyanacrylates, silicone and/or epoxy. Other suitable materials may also be used.

In an embodiment, a display member may be created by depositing a patterned adhesive layer onto a substrate using any suitable coating technique, including coating techniques known in the art such as screen printing, ink jet printing, spray coating, gravure roll coating, and the like. For light activated adhesives, a photo patterning or other suitable technique may be used.

The capsules may be applied to the adhesive layer using any suitable means, such as by cascading them over the patterned adhesive layer. Only the capsules that directly contact the patterned adhesive will be retained, yielding an at least substantially uniform, closely-packed, monolayer of coating. Coating uniformity may be further improved by repeating the capsule cascading process two or more times, and also by vibrating the substrate during or after the cascading. Capsules that do not attach to the adhesive may be removed by any number of methods, including the use of gravity, suction and other methods.

Referring to FIG. 7, in an embodiment the capsules 10 may be dispersed in an optional transparent matrix medium 30 that includes transparent binder materials that protect the capsules. Suitable binder materials include, and are not limited to, styrene-acrylic copolymers such as styrene butylmethacrylate, styrene ethylacrylate, acrylic acid copolymer, styrene-olefin copolymer, polyurethane, polycarbonate, polyvinylacetate, silicone elastomers and other materials.

Suitable substrates 14 include paper, polymeric films, ITO coated polymeric films, glass, and other materials. The substrate may include or be positioned atop a printed circuit board to allow for selective application of fields to the image formation layer.

The example below is merely representative of the work that contributes to the teaching of the described embodiments and is not to be restricted by the examples that follow.

Example 1: A patterned adhesive layer was produced on an ITO-coated polyester substrate by spraying a 3M adhesive material through a metal screen (25-85 mesh) to produce the desired pattern. Encapsulated bichromal beads having a diameter of about 120 μm were cascaded over the patterned adhesive layer several times to yield a substantially uniform coating. Microscopic examination showed that the capsules were closely packed in a monolayer having a geometry corresponding to the metal screen. A top electrode of ITO-coated polyester was placed on top of the beads to form a sandwiched structure. When an electric field was applied to the structure, the beads oriented in one direction or another depending on the polarity of the field. Reversing the polarity caused the beads to change their orientation.

While the present invention is satisfied by embodiments in many different forms, there is shown in the drawings and described herein in detail, the preferred embodiments of the invention, with the understanding that the present disclosure is to be considered as exemplary of the principles of the invention and is not intended to limit the invention to the embodiments illustrated. Various other embodiments will be apparent to and readily made by those skilled in the art without departing from the scope and spirit of the invention. The scope of the invention will be measured by the appended claims and their equivalents.

What is claimed is:

1. An image formation member, comprising:
a conductive substrate;
a patterned adhesive layer on the substrate;
a plurality of capsules on the patterned adhesive layer, wherein the capsules are positioned in a monolayer in a pattern that substantially corresponds to the pattern of the patterned adhesive layer; and
a conductive layer positioned over the capsules and opposite from the patterned adhesive layer, wherein the conductive layer is at least substantially transparent.

2. The member of claim 1 wherein the patterned adhesive layer comprises a pattern of raised adhesive elements that project from the conductive substrate.

3. The member of claim 2, wherein:
the capsules have a substantially uniform diameter; and
the raised adhesive elements are spaced apart such that center-to-center spacing of the raised adhesive elements is slightly more than the diameter of the capsules.

4. The member of claim 2 wherein:
the capsules have a substantially uniform diameter; and
the raised adhesive elements have a width that is between about 5% and about 50% of the diameter of the capsules.

5. The member of claim 2 wherein the pattern comprises an at least substantially hexagonal array.

6. The member of claim 1 wherein the patterned adhesive layer comprises at least one of a pressure-sensitive adhesive, a heat-activated adhesive, and a light-activated adhesive.

7. The member of claim 1 wherein the patterned adhesive layer comprises at least one of a copolymer of styrene and acrylate, a polyester resin, polyurethane, a copolymer of acrylonitrile and vinylidene chloride, polyvinyl acetate, polyvinyl butyral, polyolefin and an epoxy.

8. The member of claim 1 wherein the capsules are dispersed in a transparent matrix medium that is positioned between the conductive substrate and the transparent conductive layer.

9. A display medium, comprising:
a substrate;
a patterned adhesive layer on the substrate;
a plurality of display elements on the patterned adhesive layer, wherein:
the patterned adhesive layer comprises a pattern of raised adhesive elements that project from the substrate;
the display elements are positioned in a monolayer in a pattern that substantially corresponds to the pattern of the patterned adhesive layer;
the display elements have a substantially uniform width; and
the raised adhesive elements are spaced apart such that center-to-center spacing of the raised adhesive elements is slightly more than the width of the display elements; and
an overlayer positioned over the display elements and opposite from the patterned adhesive layer, wherein the overlayer is at least substantially transparent.

10. The display medium of claim 9, wherein the raised adhesive elements have a width that is between and 5% and about 50% of the width of the display elements.

11. The display medium of claim 9 wherein the display elements comprise one or more of bichromal or multichromal particles, beads, capsules, cylinders or balls.

12. The display medium of claim 9 wherein the patterned adhesive layer comprises at least one of a copolymer of styrene and acrylate, a polyester resin, polyurethane, a copolymer of acrylonitrile and vinylidene chloride, polyvinyl acetate, polyvinyl butyral, polyolefin and an epoxy.

13. A method of manufacturing a display medium, comprising:
applying an adhesive material to a substrate, wherein the adhesive material is passed through a patterned screen before reaching the substrate so that the adhesive material forms a patterned adhesive layer on the substrate, wherein the pattern of the patterned adhesive layer corresponds to the pattern of the patterned screen;
depositing a plurality of bichromal capsules on the patterned adhesive layer so that the capsules form a monolayer in positions that at least substantially correspond to the pattern of the patterned screen; and
placing a conductive layer on the monolayer of capsules.

14. The method of claim 13 wherein the depositing step is repeated a plurality of times to provide a substantially uniform monolayer.

15. The method of claim 13 further comprising, after the depositing step, removing capsules that do not adhere to the patterned adhesive layer.

16. The method of claim 13 wherein the applying step comprises one or more of screen printing, ink jet printing, spray coating and gravure roll coating.

17. The method of claim 13 wherein the patterned adhesive layer comprises a light-activated adhesive, and the applying step comprises photo patterning.

18. The method of claim 13 further comprising vibrating the substrate during or after the depositing step.
